(19) United States
(12) Patent Application Publication
(10) Pub. No.: US 2017/0094281 A1
(43) Pub. Date: Mar. 30, 2017

(54) COMPRESSING HIGH DYNAMIC RANGE IMAGES

(71) Applicant: THE UNIVERSITY OF WARWICK, Coventry (GB)

(72) Inventors: Alan CHALMERS, Kenilworth (GB); Kurt DEBATTISTA, Leamington Spa (GB); Elmedin SELMANOVIC, Sarajevo (BA); Thomas BASHFORD-ROGERS, Oxford (GB)

(73) Assignee: THE UNIVERSITY OF WARWICK, Coventry (GB)

(21) Appl. No.: 15/310,914

(22) PCT Filed: May 14, 2015
(86) PCT No.: PCT/GB2015/051415

§ 371 Date: Nov. 14, 2016

(30) Foreign Application Priority Data
May 15, 2014 (GB) 1408618.5

(51) Int. Cl. H04N 19/14; H04N 19/126

(52) U.S. Cl. CPC H04N 19/14; H04N 19/126; H04N 19/184

(57) ABSTRACT

A method of compressing a high dynamic range original image to provide compressed image data for use with (i) a high dynamic range decoder for viewing the high dynamic range image and (ii) a reduced bit depth decoder for viewing an image of lower dynamic range which has been derived from the high dynamic range original image. The difference between the image of the high dynamic range original image and the lower dynamic range is measured and that difference information is compressed. Compressed image data is produced comprising the compressed image of the lower dynamic range and the compressed image data.

### TECHNICAL FIELD

A wide range of colours and lighting intensities exist in the real world. While our eyes have evolved to enable us to see in moonlight and bright sunshine, traditional imaging techniques, on the other hand, are incapable of accurately capturing or displaying such a range of lighting. The areas of the image outside the limited range in traditional imagery, commonly termed Low (or Standard) Dynamic Range (LDR), are either under or over exposed. High Dynamic Range (HDR) imaging technologies are an alternative to the limitations inherent in LDR imaging. HDR can capture and deliver a wider range of real-world lighting to provide a significantly enhanced viewing experience, for example the ability to clearly see the football as it is kicked from the sunshine into the shadow of the stadium. HDR techniques can be generated in a number of diverse ways, for example they may merge single exposure LDR images to create a picture that corresponds to our own vision, and thus meet our innate expectations. An alternate source is the output of computer graphics systems which are also typically HDR images. Further alternative sources are HDR imaging devices although these are not commonly available.

This invention is concerned with efficient storage of HDR images and video streams. Compression is vital to ensure that the content of HDR images or videos can be efficiently stored and transmitted as raw HDR content is significantly larger than raw LDR images.

### BACKGROUND ART

A typical uncompressed HDR image requires the storage of 96-bits per pixel (bpp) when compared with the 24 bpp required by traditional LDR images. At an HD resolution of 1,920×1,080 this is approximately 24 MB per frame. These sizes make raw HDR data difficult to manage and handle efficiently. A number of image formats have emerged to handle HDR images. These include the Radiance ‘.hdr’ or ‘.pic’ file that requires 32 bpp, the OpenEXR format that can store full or half float for 96 bpp or 48 bpp respectively and the LogLUV format that supports 24 bpp and 32. These formats are frequently compressed with lossless compression methods to achieve modest gains in terms of storage. However, such methods are still insufficient to handle HDR still images and video data efficiently.

Another aspect to consider about HDR imaging is that HDR content cannot be natively displayed on LDR displays. A series of methods collectively known as tone mapping operators have been developed that can be applied to the HDR content to convert it to LDR content that is suitable to be viewed on a traditional LDR display

HDR compression methods for both still images and video can be broadly divided into two categories, those that are backwards-compatible and those that are not. The backwards-compatible methods produce a format which can be, partially, directly viewed by a traditional LDR viewer without any modifications to the software. The content that an LDR player displays for the backwards-compatible method is an LDR stream (or image) which is sub-part of the full stream (or image). Alternately, if a specialised player is available, the HDR content can be extracted; typically, by inverting the tone mapping process and using information embedded in the format in addition to the video stream.

A backwards compatible method is disclosed in PTL 0001: U.S. 2012230597 A (WARD ET AL). Sep. 13, 2012.

. A data structure defining a high dynamic range image comprises a tone mapped image having a reduced dynamic range, and separate HDR information. The high dynamic range image can be reconstructed from the tone mapped image and the HDR information, and viewed using an HDR decoder. The data structure is backwards compatible with legacy hardware or software viewers, which can use the tone mapped image and a standard LDR decoder.

Non-backwards compatible methods on the other hand cannot be displayed with existing LDR viewers and instead use proprietary viewers to display the HDR content on either an LDR or HDR display.

A non-backwards compatible method is disclosed in PTL 0002: WO WO 2010/003692 (THE UNIVERSITY OF WARWICK). Jan. 14, 2010.

. The system described divides the HDR content into two streams. A first stream is a luminance, or base, stream of frames which have been obtained by bilateral filtering of the original frames. These frames are subsequently tone mapped. A second stream, composed of detail frames including colour detail, is obtained by comparing the original frame with the base frame. The decoding process involves inverse tone mapping the base frame and re-combining with the detail frame.

Known backwards-compatible methods use various forms of tone mapping to compress the luminance of the HDR stream or still image to an LDR image before encoding it. This enables the encoded still-image/stream to be backwards compatible and it makes it possible to use legacy viewers. However, tone mapping can result in different types of artifacts, and requires a choice of tone mapper and an understanding of the settings. One object of embodiments of the present invention is to provide compression of an HDR image in which it is not necessary to know a method used for tone mapping and the settings used, in order to view the LDR image and which, at least in some embodiments, is backwards compatible and thus will run on traditional decoders and players.

A digital image comprises a collection of pixels arranged on a regular grid. There is a plurality of colorant channels to describe the colour at a pixel. For example, there may be three channels for red green and blue channels in an RGB system or four channels in a CMYK system, representing cyan, magenta, yellow and black. In these arrangements, the human sensation of brightness or lightness is represented only indirectly and the colour information is transformed to a quantitative representation of brightness before compression. For example, the colour components of an RGB image may be converted to a luminance value. This may be a weighted average of the RGB input, to account for the responsiveness of the human eye. For example, the luminance L may be determined in accordance with the following equation:

L =0.229*R +0.587*G +0.114*B (1)
Reference may be made the CIE (Commission internationale de l'Eclairage) colour space.

Other systems for denoting the colour of a pixel may have a direct value for brightness, lightness or luminance, for example the YCBCR system where Y is the luma component, CB is the blue difference chrome component and CR is the red difference chroma component. In the broad description of the present invention, reference will be made to a brightness value which is indicative of the brightness of a pixel, and this may be a designated luminance, brightness or lightness value in accordance with a colour designation system, or a derived luminance, brightness or lightness value in accordance with a colour designation system, or a value which is a function—such as a log—of such a designated or derived value. The values indicative of the brightness of a pixel will be assigned to a plurality of quantized values.

### DISCLOSURE OF INVENTION

In accordance with the present invention, there is provided a method of compressing a high dynamic range original image to provide compressed image data for use with (i) a high dynamic range decoder and (ii) a reduced bit depth decoder for viewing an image of lower dynamic range which has been derived from the high dynamic range original image, wherein each pixel of the high dynamic range original image is associated with a brightness value indicative of the brightness of the pixel; wherein the method comprises
selecting a contiguous range of brightness values for pixels suitable for use in the image of lower dynamic range, the contiguous range having a minimum brightness value and a maximum brightness value;
for pixels in the original image with associated brightness values within said contiguous range, incorporating those pixels in the image of lower dynamic range;
for pixels in the original image with associated brightness values less than the minimum brightness value of the contiguous range, adjusting the associated brightness values of those pixels to said minimum brightness value and incorporating those pixels in the image of lower dynamic range;
for pixels in the original image with associated brightness values greater than the maximum brightness value of the contiguous range, adjusting the associated brightness values of those pixels to said maximum brightness value and incorporating those pixels in the image of lower dynamic range;
determining difference information indicative of the difference between the image of lower dynamic range and the high dynamic range original image; subjecting the image of lower dynamic range to compression and subjecting the difference information to compression;
and creating compressed image data comprising the compressed image of lower dynamic range and the compressed difference information.

There is thus provided an alternative technique for providing backwards-compatible HDR compression, suitable for still images or video frames. Instead of applying tone mapping to produce an LDR image, those pixels of the original HDR image with associated brightness values which are within the contiguous range are used in the LDR image. Those pixels of the original HDR image with associated brightness values which are outside the contiguous range have their brightness values truncated so as to lie at the extremities of the contiguous range, and the pixels with truncated brightness values are used in the LDR image

As referred to in this specification, “brightness” is not limited to luminance values, but can be a designated luminance, brightness or lightness value in accordance with a colour designation system, or a derived luminance, brightness or lightness value in accordance with a colour designation system, or a value which is a function—such as a log—of such a designated or derived value, or can be another parameter which is associated with brightness such as a measure of visual attention, such as saliency so pixels that a person is more likely to look at are given more importance or luminance weighted by saliency of the pixels. In some embodiments of the invention, “brightness” is an indication of the visual importance that a person would give to pixels. The expression “brightness” also includes values which are weighted by another parameter, such as weighted luminance values in which the luminance values are weighted by, for example, the saliency so that more salient pixels have a weighted luminance value which is in accordance with their increased saliency.

In preferred embodiments, the contiguous range of brightness values is optimised so that it contains the maximum number of pixels of the original image and/or so that it includes the brightness values which occur the most frequently in the pixels of the original HDR image. It will be appreciated that there will be a number of LDR images that can be obtained using the pixels of the original HDR image. In general, the aim is to provide the optimum LDR image that can be obtained using the brightness values of pixels in the original HDR image and this can be achieved by selecting a contiguous range which contains the maximum number of pixels of the original image and/or includes the brightness values which occur the most frequently in the pixels of the original HDR image, and/or includes the maximum number of brightness values which occur in the pixels of the original HDR image.

The brightness values for pixels suitable for use in the image of lower dynamic range may be considered as those suitable to occupy the bit-depth or range of the encoder to be used for encoding the LDR image, or as those suitable to occupy the bit-depth or range of a decoder to be used when viewing the LDR image.

The image to which the invention is applied may be a single image or a frame of a stream of frames forming a video.

The LDR image which is constructed without tone mapping, presents the user with a more readily understandable image when this is viewed on an LDR display. Tone mapped images are frequently considered unrealistic by the general public, who are used to seeing traditional images. Furthermore, when encoding, there is not the additional problem of selecting the correct tone mapper to do the job. Although there are many different types of tone mappers there is no consensus on which the best one is; a number of evaluation studies have been conducted and they differ in the results. There is evidence, too, that tone mapped images can change the visual attention of an image. Furthermore, different tone mappers can perform better on different images/frames or even on different parts of the same image/frame. The choice of tone mappers and the setting of the individual parameters for any given tone mapper is thus quite a difficult task for non-experts. A correctly chosen LDR image obtained in accordance with the present invention corresponds to the type of images users expect to see from an imaging system and avoid the artifacts common to tone mapping algorithms.

A method in accordance with the invention avoids the problems with tone mapping by extracting an LDR image designed to fit the size of the encoder used to encode the LDR image. The size of the extracted range equates to the bit-depth supported by a given encoder. Typically this will be 8-bit for most encoders but support for other profiles do exist and the method natively adapts to be able to support these profiles such as 10-,12-,14- or 16-bit and any other bit depths that may be, or may become, available. If the HDR image is not a very high dynamic range, the residuals would be very small (or in certain cases non-existent), so the size of the final compressed image/video would be relatively small.

At the decoding end, the procedure carried out for viewing the LDR image is comparable to that for traditional compressed HDR images which include a backwards compatible LDR image that has been obtained by tone mapping. The procedure for viewing the HDR image uses the restored LDR image and the difference data.

### BRIEF DESCRIPTION OF DRAWINGS

FIG. 1 is a schematic diagram of a method for encoding an image in accordance with the invention;

FIG. 2 is a histogram of luminance values of pixels in an HDR original image;

FIG. 3 is an enlarged portion of the histogram of FIG. 2;

FIG. 4 is a schematic diagram of a method for decoding an image encoded in accordance with the invention, to produce an LDR image; and

FIG. 5 is a schematic diagram of a method for decoding an image encoded in accordance with the invention, to produce an HDR image.

### DESCRIPTION OF EXAMPLES

In an embodiment of the invention an LDR image derived from the pixels of the HDR image is identified and residual information is stored separately. The LDR image is computed by a function which optimises for a particular characteristic. In one particular embodiment the function selects the contiguous area of the histogram with luminance values to fit within the LDR image (or to occupy the bit-depth or range of the LDR encoder to be used) with the highest luminance. In another embodiment the log encoded largest contiguous area of the histogram which fits in the LDR image or to occupy the bit-depth of the LDR encoder is stored. Once the LDR image is chosen it is compared (through division, subtraction or any other suitable function) with the original HDR image and residuals are computed.

The contiguous area of luminance is computed by maximising the luminance for a number of pixels that fall within the contiguous range of luminance such that the luminance fits within the encoder's bit depth:

Maxf(I(E)) (2)
where the function f( )counts the number of well exposed pixels in an HDR image I at exposure E.

The function f( )is defined as follows:

f(I(E))=Σ^{p#pixels} {1 if (2^{BD}−1)*1ₚ(E)#[a . . . b]; 0 otherwise} (3)

This calculates for each pixel in the image (or a chosen representative subset of the pixels in the image; such as a down sampled image or randomly or pseudo-randomly selected pixels), p, if the pixel value at the current exposure Iₚ (E) scaled by the bit depth BD of the encoder is within a predetermined acceptable range [a . . . b] which depends on the encoder.

An implementation of the above could initially organise all pixels (or the chosen subset of pixels) into a histogram of luminance although another characteristic indicative of brightness could be used. Indeed, other characteristics which are only indirectly indicative of brightness or are indicative of a function of brightness could be used as the basis of the histogram. For example, the histogram could be based on spatial edges, or it may be based on a map of visual attention so pixels that a person is more likely to look at are given more importance—these are calculated as a separate process by established techniques called saliency maps—so the histogram is based on salient pixels rather than brightness. The histogram could be based on weighted luminance, in which the luminance values of pixels are weighted in accordance with their saliency. In an embodiment in which the histogram is based on brightness, a range within the histogram which includes the highest number of entries in the histogram bins is chosen to fit within the encoder's bit-depth (typically 8-bit but sometimes more). Once the range is chosen, all pixels with a luminance or other characteristic for which the range of luminance is less that the chosen range are set to the lowest value in the range and all those with a value higher than the chosen range are set to the highest value. If the range of the entire histogram fits within the range of the encoder the original HDR image is not modified as it can be encoded natively.

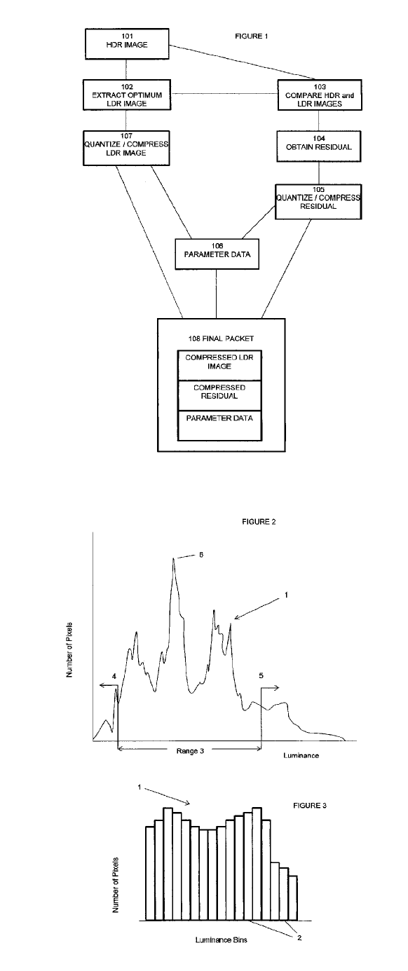

FIG. 1 is a schematic diagram of a backwards compatible process for compressing and HDR image, which may be a still image or a frame of a video stream. At 101, an HDR image is received. At 102, an optimum LDR image is extracted using a process explained below. At 103, the original HDR image and the optimum LDR image are compared, for example using division or subtraction, and at 104 a residual is obtained. This residual is quantized/compressed at 105 and the method and parameters used are stored at 106. At 107, the extracted LDR image is quantized and compressed and the method and parameters used are also stored at 107. At 108, a final compressed packet of data is created which incorporates the compressed LDR image, the compressed residual and the parameter data for use in expanding both the LDR image and the residual.

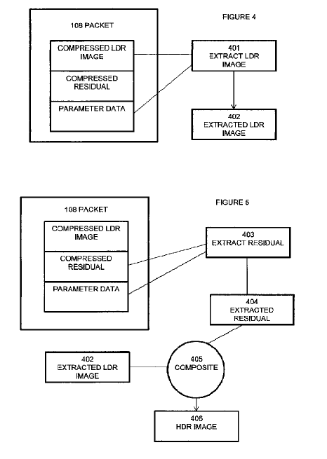

FIG. 2 shows an example of a histogram 1 used in an embodiment of the invention. In this case, the histogram represents the occurrence of luminance values in the original HDR image. FIG. 3 shows how the histogram 1 consists of a number of bins 2, each of which covers a range of luminance values. A contiguous range 3 of the bins is selected in the histogram of FIG. 2 which contains pixels whose luminance values can be accommodated within the bit depth of the LDR encoder used to encode the LDR image (and the LDR decoder that will be used to decode the LDR image). The range has a minimum luminance value 4 and a maximum luminance value 5, and is optimised so that the range includes the maximum number of pixels that can be used in the LDR image and in this embodiment also includes the peak 6, which is the luminance value which occurs the peak number of times in the original HDR image (i.e. the luminance bin which contains the maximum number of entries).

To select the optimum range of brightness values, in this embodiment the selected range contains the maximum number of possible pixels in the original HDR image that satisfy the requirements of function f( )as set out in equation (3) above, i.e. the area under the histogram within the range is maximised. There are various ways of doing this but in one embodiment, starting at the first bin the value of all the bins within a given range is checked. This value then represents the current maximum and is stored. The process then cycles through all the bins doing the same thing (calculating maximum luminance in that range) and checking if the new value is greater than the stored maximum. If it is it becomes the new maximum. The point in the bin representing the minimum luminance and the end of the range representing the maximum luminance of the chosen range are also stored, or these can be calculated later.

In an alternative embodiment the luminance of the pixel is weighted by a function that defines its importance. Such functions may include functions that detect edges, saliency or visual attention maps, or particular weightings which favour darker or brighter areas and/or a user selected portion of the screen. In such an embodiment the weighted luminance is maximised such that the dynamic range of the weighted luminance or log of weighted luminance fits within the chosen bit-depth. In a particular implementation, a histogram of weighted luminance is constructed by weighting the luminance by the weights provided from the importance. Each bin also stores the total luminance for that particular bin. The algorithm follows the same process as the one described above for luminance. A number of bins are consulted such that the total luminance of the number of bins chosen fits within the dynamic range of the chosen bit-depth. This can be done by starting at the start of the histogram and storing the current selections as the maximum value. The algorithm once again cycles through all the bins storing the current maximum. At the end the current maximum is the chosen range, the minimum and maximum luminance of that given range is chosen and stored as with the algorithm given above.

For still images, the chosen LDR image is compressed via a traditional LDR encoder (for example, but not limited to, JPEG) and will constitute the body of the file. For video streams, the chosen single exposure is encoded via a traditional LDR encoder (for example, but not limited to, MPEG) or any other existing or future encoder that supports any form of visual encoding. The method can be applied to the key frames of an MPEG stream and the predicted (difference) frames.

The residuals are stored in another channel or in a sub-band after quantisation and compression. A function of the residual values may be stored instead, such as the logarithm of the residuals. The residuals can consist of colour or luminance only data. In an embodiment the residuals are stored in a single file for images and a single stream for video. In another embodiment, the residuals may also be stored in two separate sets, representing the higher dynamic range and the lower dynamic range. Values in the higher dynamic range can be quantised more aggressively due to the human visual system's ability to notice changes in luminance at lower values more than at higher values. The scale value and the method used are also stored in the header and/or additional stream where the size of the chosen bit depth is also stored. In another embodiment the LDR image is decoded, reconstructed back to HDR and compared with the original HDR frame/image in order for the residual to be computed.

The data for the LDR image, as well as any other information or parameters required for reconstruction are stored as part of the header or a separate stream. In an embodiment the choice of the LDR frame takes temporal data into account to ensure the encoded LDR stream does not contain sudden jumps in luminance or flickering. This can be accomplished by temporally filtering the chosen range of luminance across frames using a variety of filters such as, but not limited to, box, Gaussian or triangle filters. Separate shots or series of frames with the same or similar luminance range may have filtering applied to them individually.

The decoding procedure on a traditional LDR viewer will show only the single exposure image that has been stored in the encoded still image/stream. When viewed on a specialised HDR viewer, the LDR image is scaled back up to the original values and the residuals are composited back onto the image.

FIG. 4 illustrates the steps required to decode the LDR image. Starting with the packet 108 obtained by the method of the invention as described above with reference to FIGS. 1 to 3, at 401 the compressed LDR image and the parameter data for the LDR image are used in an extraction process to produce an LDR image 402 which can be viewed on a standard viewer.

FIG. 5 illustrates the steps required to decode the HDR image. Starting with the packet 108 obtained by the method of the invention as described above with reference to FIGS. 1 to 3, at 403 the compressed residual and the parameter data for the residual are used in an extraction process to produce an extracted residual. At 405, the residual and the LDR image 402 extracted by the method described with reference to FIG. 4 are used to create the complete HDR image 406.

In preferred embodiments of the invention the difference information is determined by reference to a bit depth of an eventual HDR encoder.

Generally, a lower dynamic range image may use 8 bits, which provides 256 possible values. If it is a grayscale image, there will thus be 256 levels of grey. If it is a colour image, using three colour channels (e.g. Red, Green and Blue) there will be 256 levels of colour per colour channel, and a total bit depth of 24 bits per pixel. For a 16 bit encoder or decoder for low dynamic range images, there will be a total of 65,536 levels of colour per channel and a total bit depth of 48 bits per pixel.

In general a high dynamic range still image or image in the form of a frame of a video stream has an unlimited range of levels of colour for each colour channel, as does light in the real world and the encoder or decoder will cope with this. Typically, floating point notation is used. Single precision floating point numbers under the IEEE 754 standard require 32 bits. Thus there is required a total bit depth of 3×32, i.e. 96, bits per pixel. Other methods of representing the unlimited range of values could be used.

The invention also extends to an encoder configured to carry out the encoding process of the invention, as well as to computer software for programming data processing apparatus for carrying out the encoding process of the invention. Computer software may be provided in transitory form , for example as a download over a network such as the Internet, or in non-transitory form such as data recorded on a CD, DVD, solid state memory device, hard disk or any other type of storage device.

1. A method of compressing a high dynamic range original image to provide compressed image data for use with (i) a high dynamic range decoder for viewing the high dynamic range image and (ii) a reduced bit depth decoder for viewing an image of lower dynamic range which has been derived from the high dynamic range original image; wherein each pixel of the high dynamic range original image is associated with a brightness value indicative of the brightness of the pixel; wherein the method comprises selecting a contiguous range of brightness values for pixels suitable for use in the image of lower dynamic range, the contiguous range having a minimum brightness value and a maximum brightness value; for pixels in the original image with associated brightness values within said contiguous range, incorporating those pixels in the image of lower dynamic range; for pixels in the original image with associated brightness values less than the minimum brightness value of the contiguous range, adjusting the associated brightness values of those pixels to said minimum brightness; for pixels in the original image with associated brightness values greater than the maximum brightness value of the contiguous range, adjusting the associated brightness values of those pixels to said maximum brightness value; and incorporating in the image of lower dynamic range, the pixels with brightness values adjusted to the minimum brightness value and the pixels with brightness values adjusted to the maximum brightness value; determining difference information indicative of the difference between the image of lower dynamic range and the high dynamic range original image; subjecting the image of lower dynamic range to compression and subjecting the difference information to compression; and creating compressed image data comprising the compressed image of lower dynamic range and the compressed difference information.

2. A method as claimed in claim 1, wherein the contiguous range of brightness values includes the brightness values which occur the most frequently in the pixels of the original high dynamic range image.

3. A method as claimed in claim 1, wherein the contiguous range of brightness values is selected to maximise the number of pixels which are suitable for use in the image of lower dynamic range

4. A method as claimed in claim 1, wherein the brightness values for pixels suitable for use in the image of lower dynamic range are chosen to fit within the bit depth of an encoder for the lower dynamic range image.

5. A method as claimed in claim 4, wherein the bit depth of the encoder for the lower dynamic range image is selected from the range of 8 bits to 16 bits per colour channel of a pixel.

6. A method as claimed in claim 1, wherein brightness values of pixels of the original high dynamic range image are organised into bins of a histogram of the frequency of occurrence of brightness values and a contiguous range of bins of the histogram is selected.

7. A method as claimed in claim 1 wherein the brightness value is the luminance associated with a pixel or a function of the luminance associated with a pixel.

8. A method as claimed in claim 1 wherein the compressed image data includes data identifying the type of compression used to compress the lower dynamic range image and parameters of compression and the type of compression used to compress the difference information and parameters of compression.

9. A method as claimed in claim 1 wherein the difference information is separated into higher brightness value information and lower brightness value information and the higher brightness value information is compressed separately from the lower brightness value information.

10. A method as claimed in claim 9 wherein the higher brightness value information is compressed more aggressively than the lower brightness value information.

11. A method as claimed in claim 1, wherein the difference information is determined with reference to the bit depth of a decoder for use with the high dynamic range image and the compressed image data includes data identifying this bit depth.

12. (canceled)

13. (canceled)

14. A method as claimed claim 1, wherein the compressed image data for use with the high dynamic range decoder for viewing the high dynamic range image, has a bit depth of at least 32 bits per colour channel of a pixel.

15. A method of decoding compressed image data produced by a method as claimed in claim 1 to produce the image of reduced dynamic range, comprising decoding and expanding the image of reduced dynamic range.

16. A method of decoding compressed image data produced by a method as claimed in claim 1, to produce a high dynamic range image, comprising decoding and expanding the image of reduced dynamic range, decoding and expanding the difference information, and using the decoded and expanded reduced dynamic range image and the decoded and expanded difference information to create the high dynamic range image.
